(19) United States
(12) Patent Application Publication
(10) Pub. No.: US 2003/0060085 A1
(43) Pub. Date: Mar. 27, 2003

(54) Circuit board IC card connector

(76) Inventor: Kenneth Reece, Arroyo Grande, CA (US)

Correspondence Address: Mr. Kenneth Reece, 3689 Alisos Road, Arroyo Grande, CA, 93420, US

(21) Appl. No.: 10/243,350

(22) Filed: Sep. 12, 2002

Related U.S. Application Data
(60) Provisional application No. 60/322,532, filed on Sep. 15, 2001.

(51) Int. Cl. H01R 24/00

(52) U.S. Cl. 439/630

(57) ABSTRACT

A device for establishing electrical connection between at least one contact pad on an integrated circuit (IC) card and corresponding conductive elements of a printed circuit board (PCB) having a plurality of evenly aligned brush contacts comprised in the PCB. An optional housing is adapted to apply pressure to the inserted card to press the contact pad of said card against the contacts comprised in the PCB.

Each contact comprised in the PCB comprises a contact leg and a contact head that is attached to an open end of said contact leg. The contact legs are created and made flexible by removing unwanted parts of the PCB thus creating desired gaps between said contact legs. The contact head is created by attaching a conductor to the open end of a contact leg.

The housing and the PCB together define a card insertion plane therebetween having a card insertion ingress at a front boundary thereof.

### CROSS-REFERENCE TO RELATED APPLICATION

This application is entitled to the benefit of Provisional Patent Application Ser. No. 60/322,532 filed Sep. 15, 2001.

### FEDERALLY SPONSORED RESEARCH

Not Applicable

### SEQUENCE LISTING OR PROGRAM

Not Applicable

### BACKGROUND—FIELD OF INVENTION

The present invention relates generally to an apparatus that electrically connects an integrated circuit (IC) card to a printed circuit board (PCB), specifically to an IC card read/write device comprised in the PCB thereby obtaining a low profile above the PCB.

### BACKGROUND—TERMINOLOGY

In the context of the invention, “card” means all types of cards of the kind incorporating a hybrid or monolithic integrated circuit or “microchip”. The term “microcircuit” will be used hereinafter.

The term “card” is also used to describe a microchip by itself or integrated with other objects. Examples of such objects are credit cards, memory cards, SIM cards used in cellular phones, keys or key-rings. The term “card” is further used to describe the microchip integrated with any other object than those mentioned in the example.

In this disclosure, the terms “IC card”, “chip card”, “smart card” and “card” will be used interchangeably to denote integrated circuit cards of this type.

The term “printed circuit board” or “PCB” is used to describe any type of circuit board with interconnecting conductors, regardless of the method used to manufacture said circuit board.

The microcircuit is usually based on a microprocessor or a microcontroller including memory circuits, for example of the “PROM” or “EEPROM” type. It must be possible to insert this type of card into dedicated devices for reading and/or writing data. For the sake of simplicity, this device will be referred to as a “reader” hereinafter, it being understood that it can equally write data and perform other ancillary functions (such as electrical power supply, tests) referred to hereinafter. The data is stored in the aforementioned memory circuits, usually in encrypted form. It is therefore read from memory locations or written to memory locations.

Other logical architectures are used in particular for “electronic purse” or similar type applications.

In all cases there are input-output members in the form of contact areas, also known as “pads”, flush with the surface of one of the principal faces of the card. Various standards (ISO, AFNOR, etc.) define the position of these contact areas. They are used not only for the aforementioned data inputs-outputs but also to supply electrical power to the microcircuit and to enable various checks to be carried out, according to the applications concerned (presence test, etc.). BACKGROUND—DESCRIPTION OF PRIOR ART

Demand For Improved Security

In correlation with an increasing demand for secure transactions and the need for increased security in regard to electronic payments and network access, the electronic industry has seen growth in the use of cards incorporating a microcircuit commonly referred to as Integrated Circuit (IC) cards.

Demand For Smaller Multifunction Devices

At the same time there has been an increasing demand for diminutive electronic devices capable of multipurpose performance, such as cellular phones with Internet access, PDA's, handheld PC's, MP3 players and many other products.

Description Of Smart Cards

These IC cards are also commonly referred to as “smart cards” and incorporate at least one electronic component to which a link must be established, either through an electrical connection (hereinafter called contact smart cards) or through a wireless connection (hereinafter called contact-less smart cards).

Contact smart cards traditionally are formed of a plastic plate having about the same thickness as a credit card, with an integrated circuit imbedded in the plastic and with contact pads on a surface of the card. Such cards come in different sizes, with the large size commonly being about the size of a credit card and with a popular small size being referred to as a MICROSIM or simply SIM card.

Description Of Link Between Card And PCB

The contact smart cards are inserted into connectors that make contact between the contact pads of the card and a plurality of contacts comprised in the connector to establish an electrical connection to the electronic components of a printed circuit board (PCB).

Common Uses Of Smart Cards

Smart cards are particularly adapted for use in industries requiring strict access or billing control and convenient as well as secure access to money and information. Such applications include public phones, vending machines, copy machines, laundromat machines, public transportation ticketing and portable devices such as cellular phones, pagers, PDAs, laptop computers and other similar electronic devices and also stationary devices such as a PC, a satellite receiver or a telephone. Such cards can also be used in applications relating to payments, loyalty programs, citizen cards, electronic elections, health services, ticketing, security access and machine controls.

The cards are commonly used to authorize transactions such as purchases of goods, for access control, for identification purposes, and to allow operation of an automobile radio. Use of smart cards for secure identity authentication purposes and for online payment transactions over the Internet are increasing.

Introduction Of The Object Of A Smart Card Reader

In order to effect electrical connection between a smart card and a PCB, an electrical connector or smart card reader is employed such that the connector securably accommodates the smart card therein. The connector serves as an interface between a smart card and a reading system that interprets the information contained in the card.

It is desirable that the connector be of small size and be constructed of a minimal number of parts.

Introduction Of Prior Art

The art has utilized numerous electrical connectors specifically designed for use in removably connecting various types of IC cards.

See the following U.S. Patents, each of which is incorporated herein by reference:

| Inventor | Pat. No. |
|---|---|
| Schuder, et al. | 6,283,376 |
| Wu, et al. | 6,280,254 |
| Yasufuku, et al. | 6,278,610 |
| Bohm | 6,275,383 |
| Nishioka | 6,267,619 |
| Heim, et al. | 6,261,128 |
| Chen | 6,261,113 |
| Neifer | 6,250,965 |
| Heim | 6,244,911 |
| McDowell, et al. | 6,244,902 |
| Beun, et al. | 6,243,273 |
| Reichardt | 6,241,557 |
| Bricaud, et al. | 6,241,545 |
| Ogura, et al. | 6,238,248 |
| Somerville, et al. | 6,234,844 |
| Odic | 6,231,395 |
| Schnell, et al. | 6,231,394 |
| Kaneko | 6,227,893 |
| Simmel, et al. | 6,220,882 |
| Hoolhorst, et al. | 6,210,233 |
| Fukuda | 6,206,732 |
| Chen | 6,206,710 |
| King | 6,200,166 |
| Luvini, et al. | 6,193,557 |
| Lim | 6,179,638 |
| Klatt, et al. | 6,176,724 |
| Sakata, et al. | 6,176,723 |
| Gottardo, et al. | 6,176,721 |
| Martucci | 6,174,188 |
| Yamagami, et al. | 6,174,187 |
| Benjamin, et al. | 6,168,082 |
| Bourne | 6,165,021 |
| Chang | 6,159,051 |
| Bernardet, et al. | 6,159,028 |
| Bricaud, et al. | 6,149,466 |
| Berg, et al. | 6,149,465 |
| Gastineau | 6,149,450 |
| Chang | 6,146,195 |
| Berg, et al. | 6,142,802 |
| Seeley, et al. | 6,132,223 |
| Chang | 6,129,588 |
| Ikemoto | 6,129,571 |
| Kihira, et al. | 6,129,558 |
| Chang | 6,126,486 |
| Lyons | 6,123,456 |
| Bricaud, et al. | 6,120,328 |
| Babineau, et al. | 6,115,263 |
| Hyland | 6,112,994 |
| Wood, et al. | 6,107,122 |
| Michaelis, et al. | 6,106,317 |
| Lotz | 6,105,872 |
| Haffenden, et al. | 6,102,743 |
| Kusakabe, et al. | 6,102,723 |
| Kubo | 6,101,372 |
| Wu | 6,099,353 |
| Hyland, et al. | 6,095,868 |
| Nishioka | 6,089,919 |
| Chang | 6,086,426 |
| Lescoat | 6,086,425 |
| Chang | 6,086,424 |
| Lotz | 6,086,423 |
| Wienand, et al. | 6,079,265 |
| Zuin | 6,068,514 |
| Davis, et al. | 6,062,911 |
| Hyland, et al. | 6,062,889 |
| Schuster, et al. | 6,062,887 |
| Pollock, et al. | 6,056,601 |
| Nishioka | 6,056,573 |
| Bricaud, et al. | 6,053,776 |
| Ungermann, et al. | 6,053,775 |
| Lok | 6,050,857 |
| Helmstetter, et al. | 6,046,913 |
| Benjamin, et al. | 6,039,599 |
| Hyland | 6,024,593 |
| Fuchs, et al. | 6,004,168 |
| Reichardt, et al. | 6,000,969 |
| Chang | 5,997,356 |
| Inadama | 5,997,345 |
| Akama, et al. | 5,997,315 |
| Klatt, et al. | 5,993,261 |
| Iguchi | 5,993,232 |
| Chan, et al. | 5,991,158 |
| Sugimoto | 5,986,891 |
| Berg, et al. | 5,980,324 |
| Bricaud, et al. | 5,980,323 |
| Kanda, et al. | 5,980,294 |
| Ichimura | 5,980,277 |
| Joly | 5,975,959 |
| Korsunsky, et al. | 5,969,330 |
| Vallat | 5,969,329 |
| Wu, et al. | 5,961,338 |
| Ichimura | 5,954,530 |
| Ichimura | 5,951,315 |
| Vallat | 5,945,662 |
| Yu | 5,941,723 |
| Roelofs, et al. | 5,926,365 |
| Sato, etal. | 5,906,516 |
| Nixon | 5,883,786 |
| Bricaud, et al. | 5,882,230 |
| Takemura | 5,850,103 |
| Bricaud, et al. | 5,823,828 |
| Delprete, et al. | 5,820,391 |
| Brioaud, et al. | 5,800,200 |
| Bricaud, et al. | 5,775,949 |
| Hashiguchi | 5,775,929 |
| Kwiat, et al. | 5,746,626 |
| Bricaud, et al. | 5,746,607 |
| Wienand, et al. | 5,744,713 |
| Kaneshige, et al. | 5,743,766 |
| Verstijnen | 5,733,147 |
| Braun, et al. | 5,718,609 |
| Brunker, et al. | 5,713,764 |
| Sakata, et al. | 5,695,353 |
| Takemura | 5,674,080 |
| Broschard, III, et al. | 5,667,408 |
| Broschard, III, et al. | 5,667,397 |
| Broschard, III | 5,653,610 |
| Nishio, et al. | 5,639,265 |
| Kinross | 5,620,342 |
| Broschard, III | 5,599,203 |
| Duke, et al. | 5,595,505 |
| Braun | 5,586,890 |
| Stipanuk, et al. | 5,580,267 |
| Sarradin | 5,574,271 |
| Mizuguchi | 5,567,171 |
| Matsushita, et al. | 5,489,216 |
| Chishima, et al. | 5,474,468 |
| Kessoku, et al. | 5,473,505 |
| Schwan, et al. | 5,470,260 |
| Bellomo, et al. | 5,449,297 |
| Thrush, et al. | 5,425,651 |
| Pickles | 5,423,691 |
| Casses | 5,395,259 |
| Hania, et al. | 5,380,997 |
| Kinross, et al. | 5,366,390 |
| Someno | 5,325,269 |
| Reichardt, et al. | 5,320,552 |
| Imai | 5,316,496 |
| Defrasne | 5,286,957 |
| Dewey, et al. | 5,286,215 |
| Thompson | 5,281,148 |
| Ozouf, et al. | 5,276,317 |
| Reichardt, et al. | 5,269,707 |
| Tseng, et al. | 5,268,820 |
| Schuder, et al. | 5,259,777 |
| Pernet | 5,252,815 |
| Duffet, et al. | 5,224,873 |
| Arai, et al. | 5,211,571 |
| Fuchs | 5,209,669 |
| Anderson, Jr., et al. | 5,205,738 |
| Martin, et al. | 5,198,645 |
| Tanuma, et al. | 5,196,994 |
| Kaneda, et al. | 5,184,282 |
| Pernet | 5,169,345 |
| Licht, et al. | 5,163,854 |
| Birch | 5,161,992 |
| Zaderej, et al. | 5,156,552 |
| Kiat-Hup, et al. | 5,154,644 |
| Ichitsubo | 5,110,309 |
| Mouissie | 5,106,307 |
| Grabbe, et al. | 5,104,324 |
| Takahashi | 5,091,618 |
| Biechler, et al. | 5,052,936 |
| Collier | 5,040,991 |
| Piorunneck, et al. | 5,035,631 |
| Gordon, et al. | 5,013,263 |
| Juret, et al. | 5,013,255 |
| Pernet | 5,012,078 |
| Komatsu | 5,000,694 |
| Buck, et al. | 4,997,376 |
| Billman, et al. | 4,973,270 |
| Yamamoto | 4,968,266 |
| Tkazyik, et al. | 4,941,830 |
| Ichitsubo | 4,932,904 |
| Scholz | 4,932,885 |
| Seidler | 4,932,876 |
| O'Brien | 4,921,453 |
| Anhalt, et al. | 4,919,626 |
| Knight | 4,915,636 |
| Walton, et al. | 4,911,653 |
| Ohkubo, et al. | 4,909,742 |
| Maillot | 4,902,233 |
| Pernet | 4,900,273 |
| Lange, et al. | 4,900,272 |
| Dranchak, et al. | 4,892,487 |
| Andrews Jr. | 4,869,672 |
| Matsuoka | 4,846,713 |
| Shino | 4,843,223 |
| Yasuma, et al. | 4,839,509 |
| Fujii | 4,820,186 |
| Komatsu | 4,810,203 |
| Kniese, et al. | 4,806,103 |
| Owen | 4,795,354 |
| Thrush | 4,781,612 |
| Hamada | 4,780,603 |
| Berg, et al. | 4,780,087 |
| Reichardt, et al. | 4,752,234 |
| Krumme | 4,734,047 |
| Owen | 4,726,775 |
| Mouissie | 4,721,348 |
| Beers | 4,720,156 |
| Sitzler | 4,705,338 |
| Mouissie | 4,701,002 |
| Hvezda, et al. | 4,700,998 |
| Grabbe, et al. | 4,695,111 |
| Massit, et al. | 4,684,181 |
| Dunn, et al. | 4,682,834 |
| Moore | 4,678,252 |
| Stipanuk, et al. | 4,665,614 |
| Furuya | 4,662,702 |
| Kikuchi, et al. | 4,645,277 |
| Krumme | 4,643,500 |
| Sonobe | 4,636,022 |
| Crawford | 4,634,210 |
| Andrews, Jr., et al. | 4,629,270 |
| Boland | 4,598,966 |
| Zrnich | 4,561,711 |
| Olsson | 4,560,221 |
| Noschese | 4,556,268 |
| Lapraik, et al. | 4,553,804 |
| Lapraik, et al. | 4,553,803 |
| Ruehl | 4,553,802 |
| Grabbe, et al. | 4,550,959 |
| Gillett | 4,548,452 |
| Gillett, et al. | 4,542,950 |
| Lumpp | 4,541,678 |
| Steele | 4,540,228 |
| Petit, et al. | 4,469,385 |
| Porter | 4,448,466 |
| Weber | 4,403,819 |
| Endoh, et al. | 4,385,795 |
| Mears | 4,142,226 |
| Sugimoto, et al. | 4,129,351 |
| Andreaggi | 4,113,342 |
| Ostapovitch | 4,070,557 |
| Benasutti | 4,026,627 |
| Vladic | 4,003,625 |
| Sherwood | 3,997,231 |
| BonHomme | 3,517,374 |
| Miller | 3,474,380 |
| Bird | 3,315,217 |
| Tuchel | 3,289,146 |
| Paholek, et al. | 3,234,499 |
| Fedder, et al. | RE32,559 |

FIG. 1.

An illustrative example of a conventional smart card reader is provided in FIG. 1, wherein a smart card connector 10 includes a housing 12 fabricated from an insulative plastic material and having a top portion 12a and a bottom portion 12b having dimensions circumscribed by a peripheral side wall 12c. Top portion 12a and bottom portion 12b together define a linear card insertion slot 14 having ingress 14a through which a smart card enters connector 10. Ingress 14a is generally sized and shaped to correspond to a smart card that is inserted therethrough.

Bottom portion 12b supports a plurality of electrical contacts 16 for electrical engagement with a contact pad of a smart card inserted thereagainst. Contacts 16 lie outwardly from a mid-section of bottom portion 12b and have tail portions 16a that extend normally relative to peripheral wall 12c. Bottom portion 12b further includes one or more securement members 18 protruding from a bottom surface thereof for alignment and securement of connector 10 with a PCB. In order to ensure sufficient termination of contacts 16 to the PCB, bottom portion 12b is positioned flush therewith.

Description Of Why The Connector In FIG. 1 Needs Improvements

Although the aforedescribed connector effectively establishes electrical contact between a smart card and a PCB, its use may not be desirable in configurations where conservation of materials and space is essential. The above design requires at least two housing portions wherein one portion must provide enough space for support of a requisite number of electrical contacts therein.

Such configuration will as a minimum require space above the PCB equal to the sum of the height of the bottom portion (12b) plus the height of the ingress 14 plus the height of the top portion (12a).

A major component of manufacturing costs is often related to the number of manufacturing and assembly operations, the latter being particularly time consuming. This configuration further comprises relatively complicated mechanical design which is contributing to increased costs associated with the manufacture of such reading devices.

Objects And Advantages

Explanation Of The Need For The Invention

There is a continuous demand to reduce the size of electrical and electronic components and also to reduce their cost.

Thus, it is desirable to provide a smart card connector that establishes electrical communication between a smart card and a PCB while minimizing the required space above the PCB for integration into diminutive devices.

It is further desirable to provide a smart card connector that implements a simple contact configuration so as to effect a satisfactory electrical connection in a manner that reduces the cost and complications of the manufacture of such device.

Advantages

From the description above, a number of advantages of the present invention becomes evident:

A) When punching out a portion of the PCB to create the contact legs, said contact legs are effectively made completely flush with the PCB, thus creating the smallest possible profile above the PCB to save valuable space.

B) The use of the PCB as the contacts, make it possible to avoid the inclusion of a separate smart card connector when manufacturing a smart card read/write device.

C) Any suitable material can be used for the housing, which make it possible to adapt other devices to function as the housing of the present invention. An example of such a device is a display that can easily be adapted to function as the housing of the present invention.

D) By re-using the punched out portions of the PCB of one embodiment of the invention, as the bottom portion of other smaller embodiments of the invention, 2 or more read/write devices can be created from the same PCB that would otherwise be used to create only 1 connector. This enables a more cost effective manufacturing process.

E) The contact heads that are created by attaching a convex shaped metal piece onto the contact legs are considerably simpler to manufacture than the relatively complicated mechanical design of the contacts of connectors of the prior art.

F) The low profile of the present invention makes the device easily integratable with other devices with diminutive features.

Summary

In accordance with the present invention a PCB and a housing attached to said PCB form an IC card connector comprising a plurality of brush data contacts that make galvanic contact with the contact pad of a correctly inserted card.

The brush contacts are created by punching out an unwanted part of the PCB, thus creating a gap between said contacts to make them flexible. The housing that is attached to the PCB is made of a suitable material that is adapted to form the top portion of a card insertion slot, with the PCB forming the bottom portion of said card insertion slot.

The housing is formed in such a way that part of the inner side of the housing has a convex shaped pressure area that applies pressure to an IC card when said card is inserted into the card insertion slot.

When an IC card is fully and correctly inserted into the card insertion slot, contact is made between the contacts comprised in the device and a contact pad on said IC card.

In the configuration according to the present invention, the reader can be made very thin which will preserve valuable space above the PCB and allow the device to be integrated into other devices that requires thin features, for example (but not limited to) cellular phones, PDAs, pagers, automobile music devices, mouse pads, displays and keyboards. Also the reader by itself form a diminutive portable smart card read/write device.

### DRAWINGS

Drawing Figures

FIG. 1 illustrates a front perspective view of a smart card connector of the prior art having a plurality of electrical contacts supported in a bottom portion of the connector housing.

FIG. 2 illustrates a front perspective view of a card read/write device of the present invention in a preferred embodiment.

FIG. 2A illustrates an exploded rear perspective view from below of an IC card being inserted into the card read/write device of FIG. 2.

FIG. 2B illustrates a cross sectional view of an embodiment of the read/write device of FIG. 2A with a card inserted, along line A-A of FIG. 2A.

FIG. 3 illustrates a front perspective view of the bottom part of the card read/write device of FIG. 2 that shows a printed circuit board (PCB) comprising a plurality of electrical contacts.

FIG. 3A illustrates a close-up of the electrical contacts of FIG. 3.

FIG. 4 illustrates a front perspective view of an alternate embodiment of the card read/write device of the present invention.

FIG. 4A illustrates an exploded front perspective view of the embodiment of the card read/write device of FIG. 4.

FIG. 4B illustrates an exploded front perspective view of an IC card being inserted into the card insertion slot of the embodiment of the present invention of FIG. 4.

FIG. 4C illustrates a front perspective view of the embodiment of the present invention of FIG. 4 with an IC card partially inserted into the card insertion slot.

FIG. 4D illustrates a front perspective view of the alternate embodiment of the card read/write device of FIG. 4.

FIG. 5 illustrates a front perspective view of an alternate embodiment of the card read/write device of the present invention, that is adapted to have 2 cards inserted at the same time.

FIG. 5A illustrates an exploded front perspective view of the embodiment of the present invention of FIG. 5.

FIG. 6 illustrates a front perspective view of an alternate embodiment of the card read/write device of the present invention.

FIG. 7 illustrates a front perspective view of an alternate embodiment of the card read/write device of the present invention.

FIG. 7A illustrates a front perspective view of an alternate embodiment of the card read/write device of FIG. 7.

FIG. 8 illustrates a front perspective view of an alternate embodiment of the card read/write device of the present invention.

FIG. 8A illustrates an exploded front perspective view of the embodiment of the card read/write device of FIG. 8.

FIG. 8B illustrates a cross sectional view of an embodiment of the read/write device of FIGS. 8 and 8A with a card inserted, along line B-B of FIG. 8A.

FIG. 9 illustrates a front perspective view of an alternate embodiment of the card read/write device of the present invention.

FIG. 9A illustrates an exploded front perspective view of the embodiment of the card read/write device of FIG. 9.

FIG. 10 illustrates a front perspective view of an alternative embodiment of the present invention. FIG. 10A illustrates a cross sectional view of the read/write device of FIG. 10 along line C-C.

FIGS. 11A-11C illustrates a front side view of different types of contact IC cards.

FIG. 12 illustrates an exploded front perspective view of a contact-less IC card.

FIG. 13 illustrates a front perspective view of an alternative embodiment of the present invention.

FIG. 14 illustrates a front perspective view of an alternative embodiment of the present invention.

FIG. 15 illustrates a front perspective view of an alternative embodiment of the present invention.

Reference Numerals In Drawings

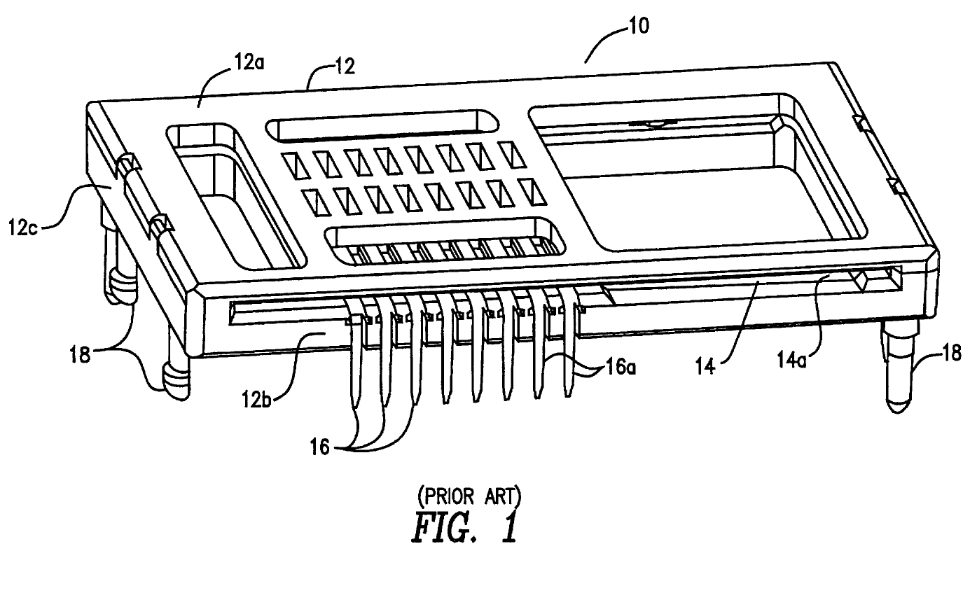

FIG. 1. (Prior Art)

10 Smart card connector

12 Housing for smart card connector

12a Top portion of housing 12

12b Bottom portion of housing 12

12c Peripheral wall

14 Card insertion plane

14a Card insertion ingress

16 Electrical contacts

16a Tail portion of electrical contacts 16

18 Securement members

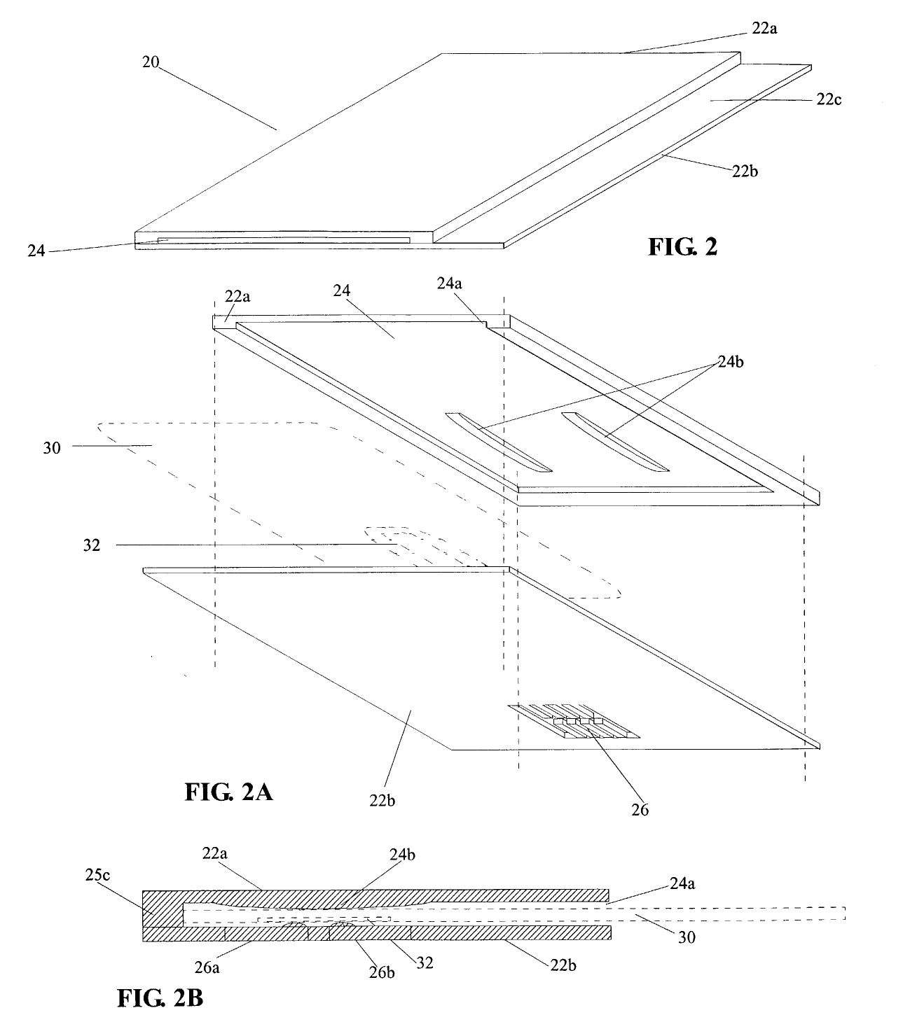

FIGS. 2-14

20 Card read/write device

22a Housing—Top portion of card read/write device 20

22b Printed Circuit Board (PCB)—Bottom portion of card read/write device 20

22c Space on PCB for components

22d Divider

22e Side edges

22f End edge

24 Card insertion plane

24a Card insertion ingress

24b Convex shaped pressure area

24c Half Circle cut out of housing 22a for easy insertion and extraction a card

24d Opening in housing 22a on 3 sides of pressure-area 24b

25a Side edge of housing 22a

25b Side edge of housing 22a opposite side edge 25a

25c End edge of housing 22a

26 Electrical contacts comprised in PCB 22b

26a Contact leg

26b Contact head

26c Half circle cut out of PCB for easy extraction of inserted card

27 Opening in PCB 22b to create contact legs 26b

28 Flexible pressure area with spring effect

30 Integrated Circuit (IC) Card

32 Contact pad of IC card 30

34 Data display

36 Navigation buttons

38 Alphanumeric keypad

40 Integrated circuit (IC) contact-less card

40a Top layer of contact-less card 40

40b Bottom layer of contact-less card 40

40c Integrated circuit chip of contact-less card 40

40d Antenna of contact-less card 40

42 Path on PCB 22b for communication with contact-less card 40

### DETAILED DESCRIPTION

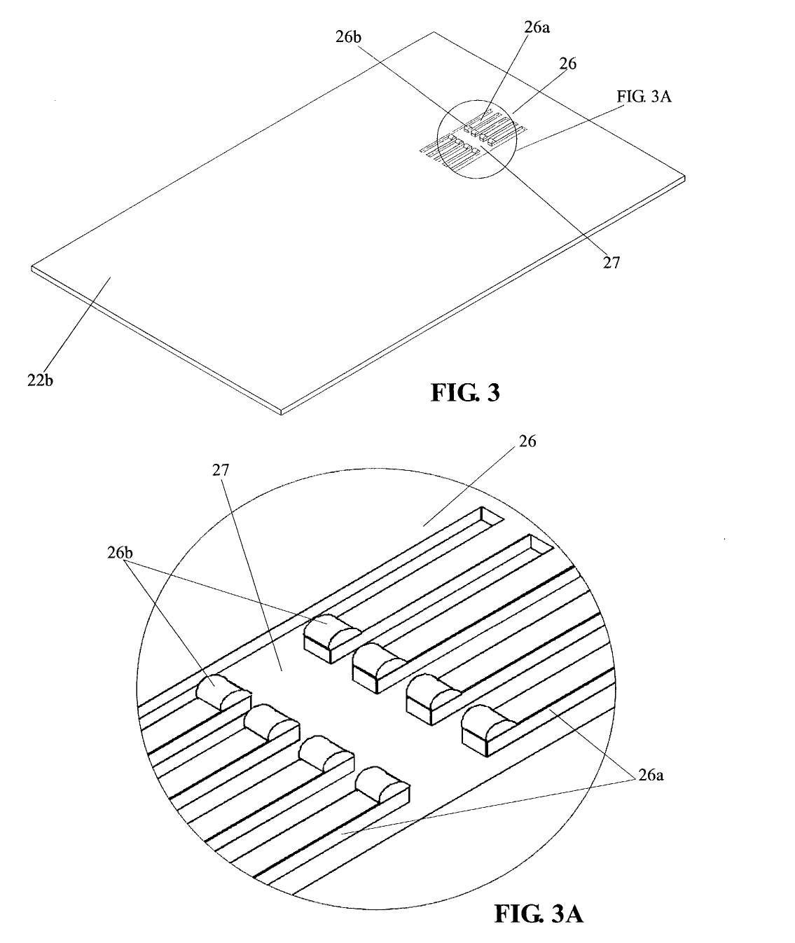

FIGS. 2-3A Preferred Embodiment

The present invention provides for an Integrated Circuit (IC) card read/write device (hereinafter called the connector) that establishes an electrical connection between at least one contact pad on the card and corresponding conductive elements of a printed circuit board (PCB).

A preferred embodiment of the connector is illustrated in FIG. 2 (front perspective view) and FIG. 2A (exploded rear perspective view from below).

The connector has a top portion 22a (the housing) and a bottom portion 22b (the PCB) that together define a card insertion plane 24 therebetween having a card insertion ingress 24a at a front boundary thereof.

In the preferred embodiment as illustrated in FIG. 2, the connector is adapted to communicate with IC cards of the regular credit card size. In other embodiments of the present invention the connector can be adapted to communicate with any other types of IC cards, by varying the size and shape of the housing and the PCB.

The Housing

The top portion of the device of the present invention (hereinafter called the housing) in the preferred embodiment is fabricated from an insulative plastic material.

The housing is injection molded in such a way, that the inner side of the housing comprise a number of convex shapes 24b (hereinafter called pressure areas) that are slightly offset from the housing plane (approximately 0.5-1.0 mm).

Three 25a, 25b and 25c of the housing 24d form a frame on three sides of an inserted card 30. Said edges functions like a guide when the card is inserted into the card insertion ingress 24a. The end edge of said frame (25c) opposite from the card insertion ingress (24a) prevents the card from being inserted too deep into the connector.

When an IC card 30 is inserted into the card insertion ingress 24a, the pressure areas 24b applies pressure to the card and force the card downward, creating a connection between the contact pad on the IC card 32 and the contact heads 26b of the electrical contacts 26 of the bottom portion of the connector 22b.

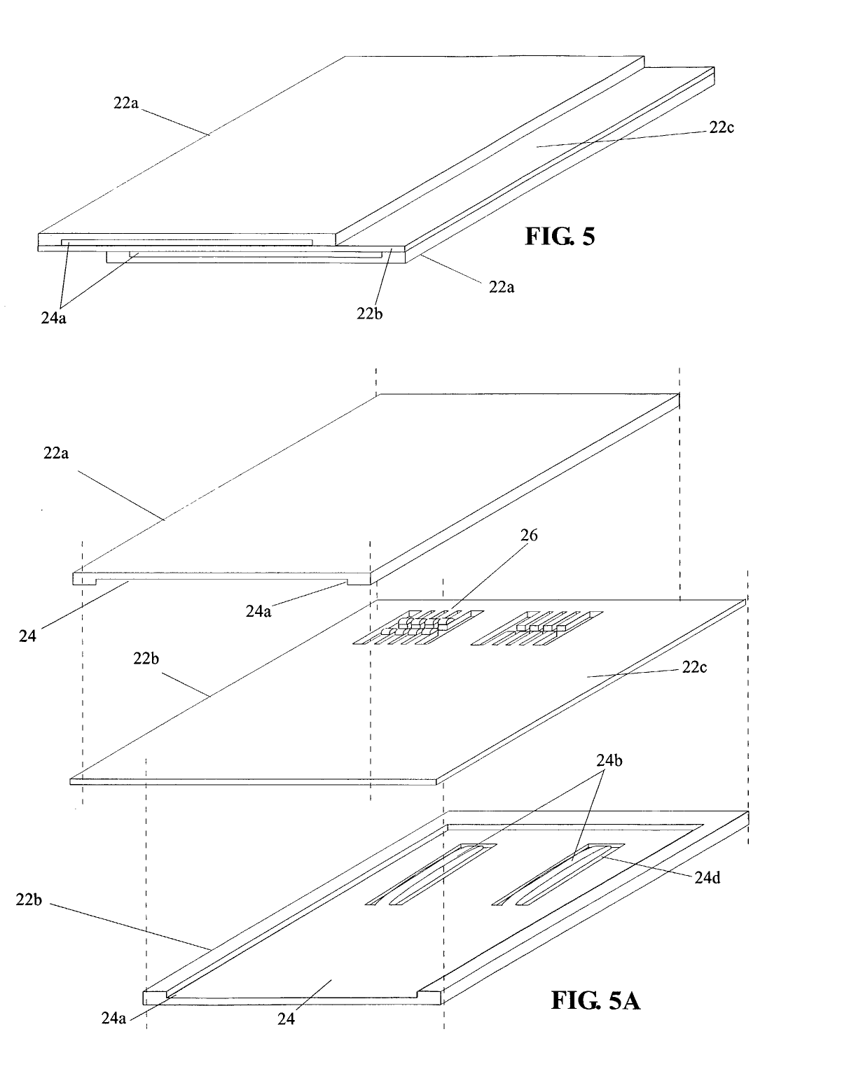

Optionally an opening 24d in the PCB 22b can be created around at least 2 sides of said pressure area 24b, to make said pressure areas flexible. This feature is illustrated in FIG. 5A.

The housing can be attached to the PCB in a plurality of ways. One simple way is to glue or solder the housing to the PCB. Another example is to comprise a number of vertical spikes along the edge of the housing, with the spikes having the same length as the height of the PCB. These spikes will then fit into a number of holes drilled along the edge of the PCB for the purpose of attaching the housing to the PCB as described.

The PCB

The bottom portion 22b of the connector 20 is a printed circuit board (PCB) that comprises a plurality of electrical contacts 26 in even, aligned distribution therein so as to effect electrical engagement between the contacts and at least one contact pad 32 on the IC card 30.

A contact 26 comprises a contact leg 26a and a contact head 26b.

The contact legs are comprised in the PCB with 1 closed end and 1 open end. Said contact legs are created by punching out a portion 27 of the PCB to create a flexible open end.

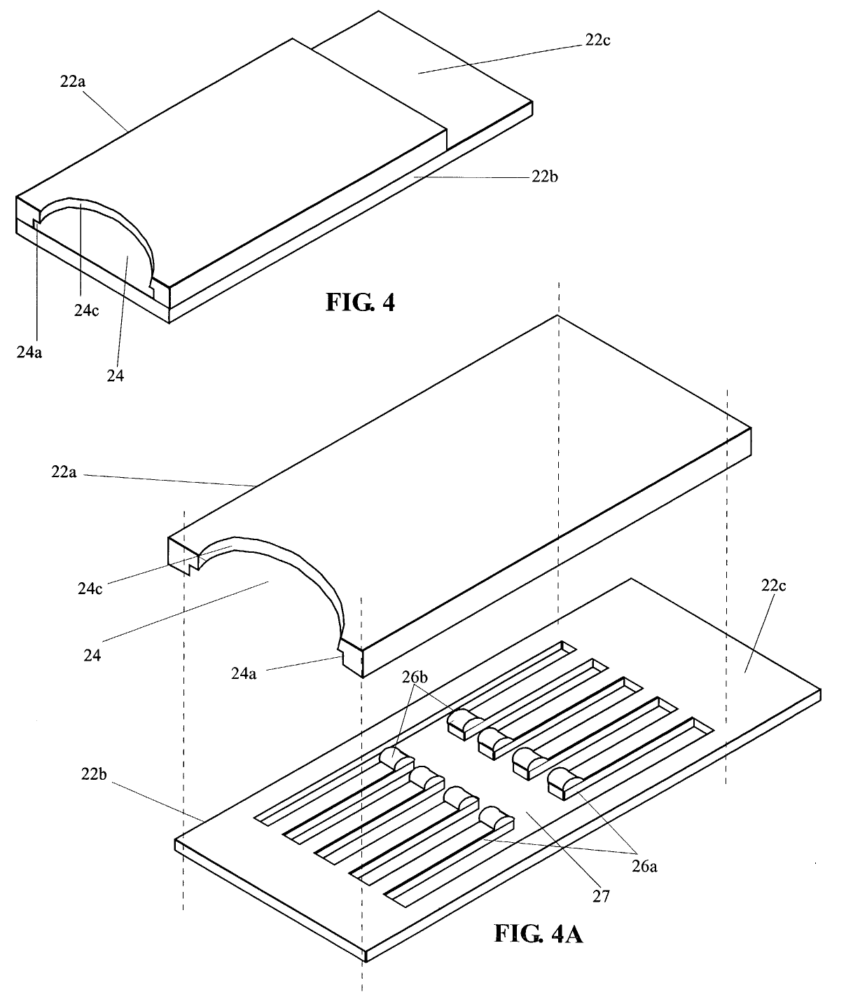

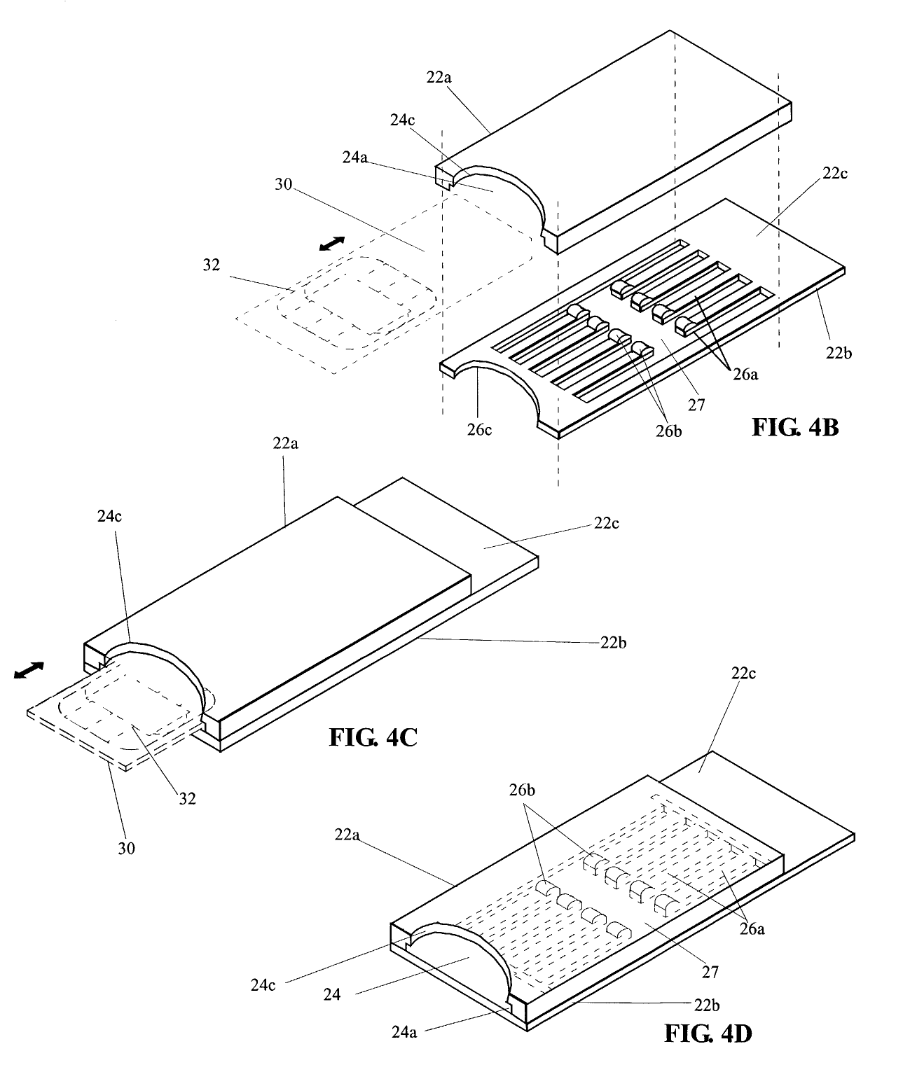

The portion of the PCB that are punched out to manufacture the embodiment of FIG. 2, can effectively be configured to function as the bottom PCB portion of another embodiment of the invention, that requires a smaller PCB area. One example of such a smaller embodiment of the invention is illustrated in FIG. 4 that shows an embodiment of the present invention that is adapted to establish communication with a SIM card.

The contact legs can be created in a plurality of ways. For example the area to be removed from the PCB can be cut out of the PCB using laser or water, it can be drilled out of the PCB, or 2 pieces of PCB can be joined together to create the same effect.

The contact heads 26b are created by integrating a convex shaped conductor with the PCB 22b at the open end of a contact leg 26a.

When connection is made between the contact head 26b and a card's contact pad 32, communication is established between the IC card and the electrical components of the PCB 22b.

In the preferred embodiment the area of the PCB 22b is larger than the area of the housing 22a, leaving space 22c on the PCB for the necessary electronic components uncovered. In alternative embodiments the housing also covers the electronic components of the PCB.

FIGS. 4-4D—Additional Embodiment

FIG. 4 illustrates an additional embodiment of the invention, where the connector has been adapted to communicate with a SIM card, of the type that is commonly used in cellular telephones.

The functionality of this embodiment of the invention is the same as described under the preferred embodiment of the invention.

To allow for easy insertion or extraction of an IC card, an optional half circle 24c and 26c can be cut out of the housing and the PCB respectively to allow 2 human (or mechanical) fingers to grab the card.

In this embodiment the available space on the PCB 22c for electronic components are placed behind the back end of the housing 22a, to allow the connector 20 to be narrow.

By changing the size and shape of the PCB and the housing, any desirable shape of the connector can be obtained. Examples of such alternative shapes are square, L-shaped and round.

FIGS. 5-5A—Alternative Embodiment 1

FIG. 5 illustrates an alternate embodiment where the preferred embodiment of FIG. 2 has been adapted to communicate with 2 cards at the same time.

In this embodiment 2 separate sets of contacts (26.1 and 26.2) have been punched out of the same PCB 22b. On a first set of contacts 26.1, the contact heads have been attached to the side of the PCB facing the housing 22a above the PCB. On a second set of contacts 26.2 the contacts have been placed on the side of the PCB facing the housing below the PCB. Thus the contact heads of the second sets of contacts 26.2 are not visible in the illustration of FIG. 5A.

In the embodiment illustrated in FIG. 5, 2 different cards can be inserted into the connector in the same direction. A first card can be inserted above the PCB 22b with the first card's contact pad 32 facing downward. A second card will be inserted below the PCB with the second card's contact pad facing upward.

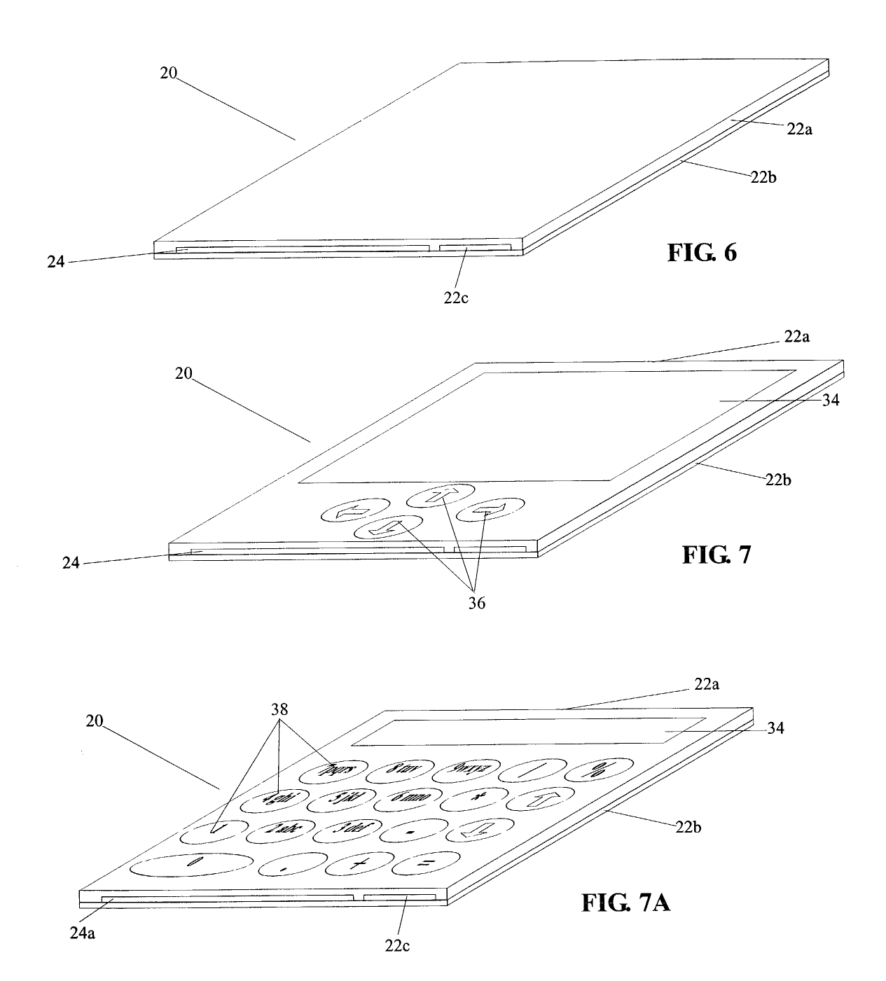

FIG. 6—Alternative Embodiment 2

FIG. 6 illustrates a moderation of the embodiment of the card read/write device of FIG. 2. In the embodiment of FIG. 6 the housing is made larger to cover the entire area of the PCB, thus providing protection for the electrical components that are integrated with the PCB.

FIGS. 7-7A—Alternative Embodiment 3

The housing of the read/write device of the present invention can be manufactured in a number of suitable materials. Any hard material can be used. In addition other known devices of the prior art that can have a flat profile such as displays, keypads, fingerprint readers, a contact-less card read/write device, or a wireless communication device can easily be adapted to function as the housing of the present invention.

In FIG. 7 the housing is formed by a display for presentation of data to the user with integrated navigation buttons for scrolling through the presented data.

FIG. 7A illustrates a card read/write device of the present invention, where the housing is formed by a numerical keypad with integrated display.

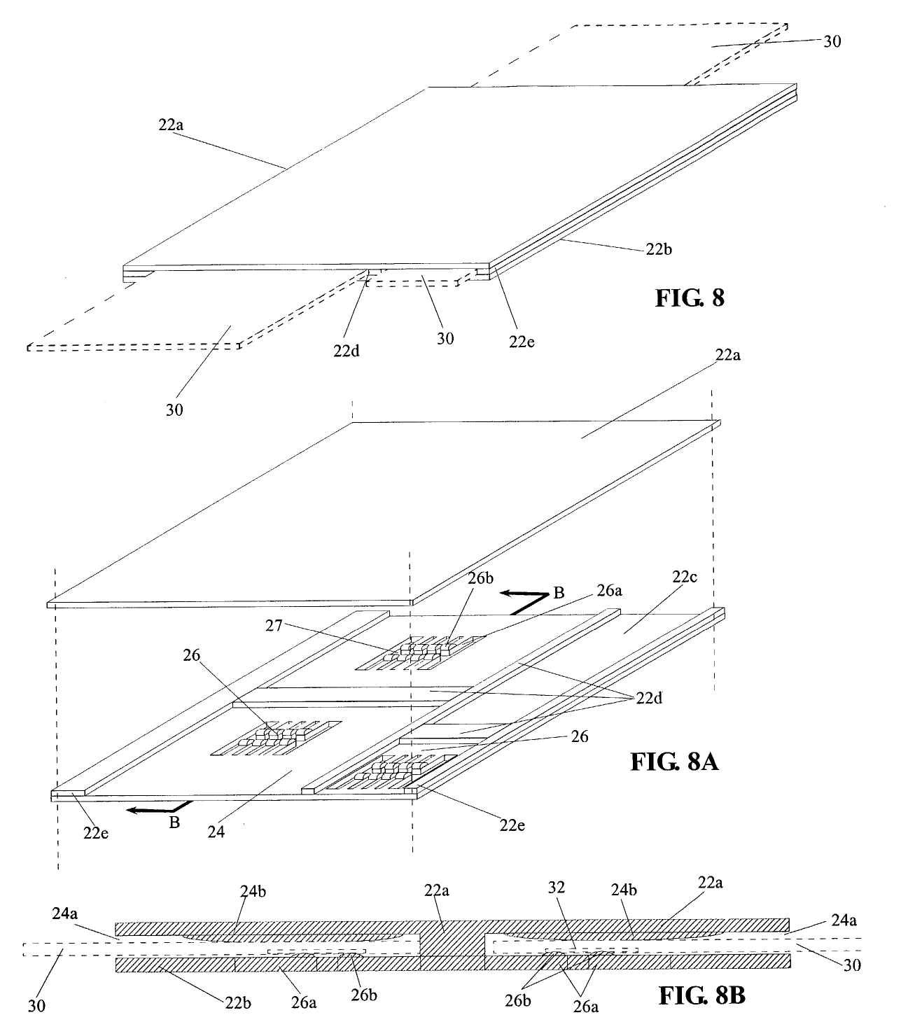

FIGS. 8-8B—Alternative Embodiment 4

In another embodiment the connector could be configured to allow the insertion of 2 or more cards on the same side of the PCB 22b (for example the upper side as illustrated in FIG. 4), from any direction. FIG. 8 illustrates an embodiment of the invention, with 2 credit-card sized IC cards and 1 SIM card inserted into the read/write device. This embodiment allows a user to copy or transfer, for example, information or stored value from 1 card to another.

The multiple sets of contacts are manufactured by punching out 2 or more sets of contacts in the same PCB and placing the contact heads on the same side of the PCB.

The housing is configured to allow insertion of more than 1 card from different directions, by placing dividers between the PCB and the housing and not having an end edge on the housing.

In the embodiment of the present invention of FIGS. 8 and 8A the housing is formed as a lid that is placed above the PCB with dividers and pressure areas placed thereinbetween.

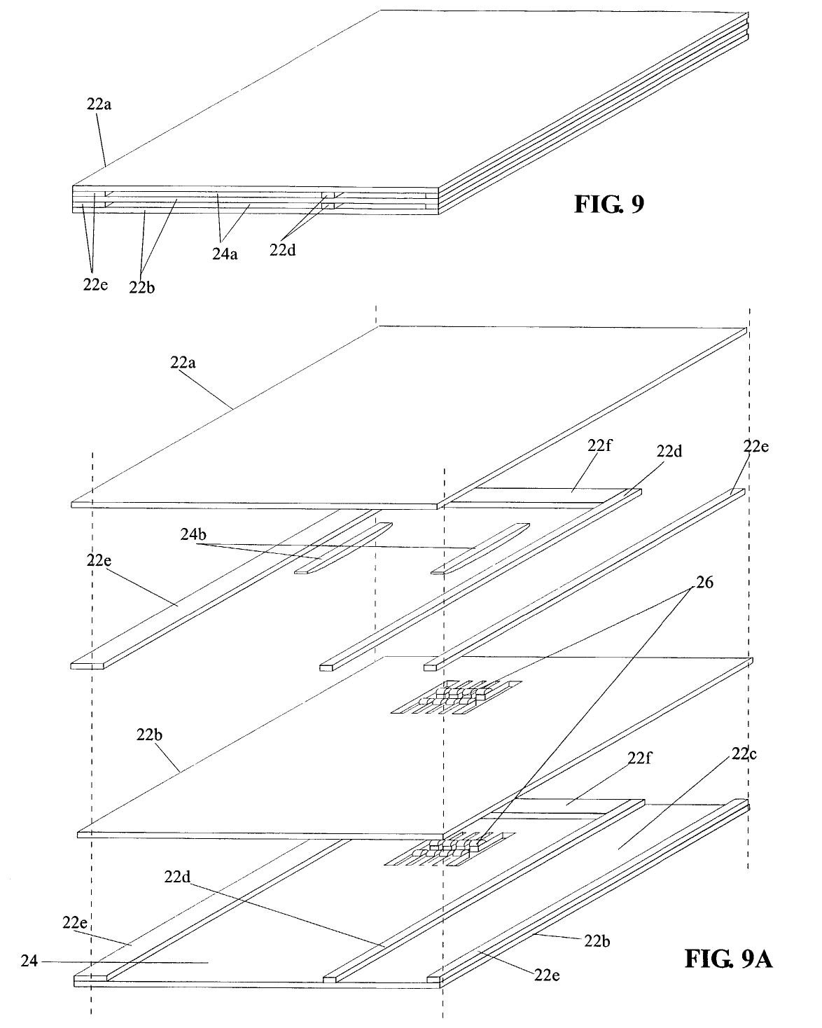

FIGS. 9-9A—Alternative Embodiment 5

In another embodiment of the present invention, the connector can be used to enable simultaneous communication with a plurality of IC cards 30 by using a second PCB 22b to function as the housing. This would in principle allow for simultaneous communication with an infinite number of IC cards. This embodiment of the invention could for example be used to simultaneously program or re-program a high number of IC cards.

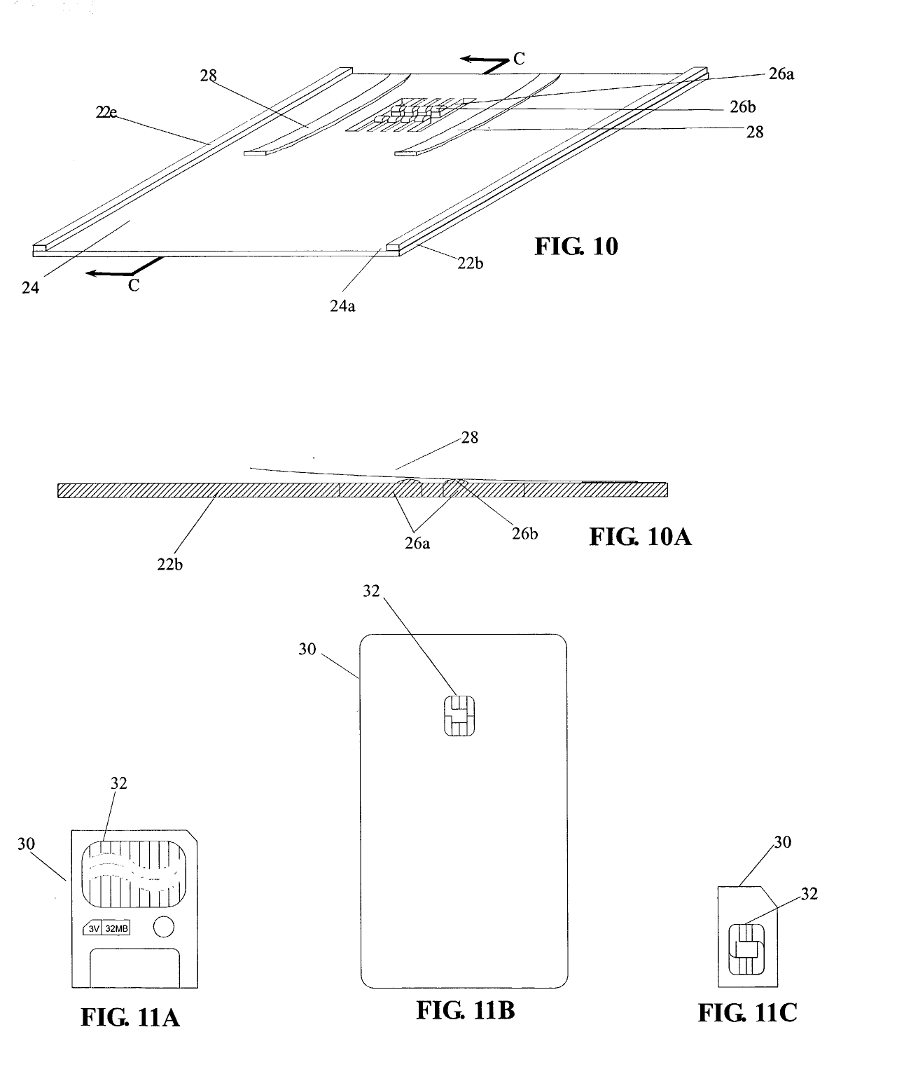

FIGS. 10-10A—Alternative Embodiment 6

In situations where it is not desirable to place a closed housing above the PCB, one or more clips with a spring effect can be integrated into the PCB to apply the necessary pressure to an inserted card. FIGS. 10 and 10A illustrate one such embodiment, with guides placed along the edge of the PCB to hold the inserted card in place.

FIGS. 11A-11C—Examples Of Different Contact IC Cards

FIG. 11A illustrates an IC card of the type commonly used in digital cameras.

FIG. 11B illustrates an IC card of credit-card size, commonly used as payment-, identification- and access cards.

FIG. 11C illustrates an IC card of the type commonly referred to as a SIM card, and commonly used in cellular phones and other portable communication devices.

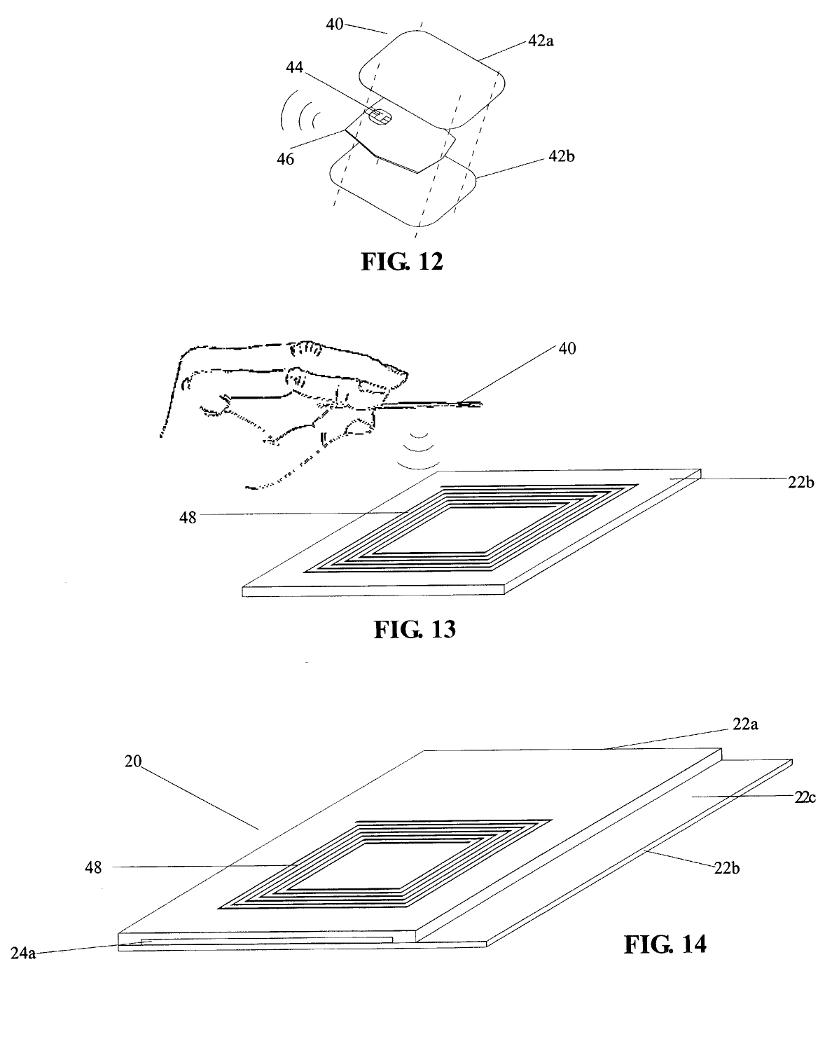

FIG. 12—Examples Of Contact-Less IC Card

FIG. 12 illustrates an exploded view of a contact-less IC card. The illustrated card consist of a top layer of plastic (42a), a middle layer comprising a microcircuit (44) and an antenna (46), and a bottom layer of plastic (42B).

FIG. 13—Alternate Embodiment 7 (Contact-Less IC Card Read/Write Device)

In the embodiment illustrated in FIG. 13, the device is adapted to couple a contact-less IC card (40) to a conductive path (48) that is comprised in the PCB (22b).

A PCB traditionally comprises a conductive integrated circuit that is printed onto a board. By forming said integrated circuit according to the path 48 of FIG. 13, a conductive path is created that is completely flush with the PCB.

FIG. 14—Alternate Embodiment 8

FIG. 14 illustrates an embodiment where the device is adapted to establish communication with both a contact IC card and a contact-less IC card.

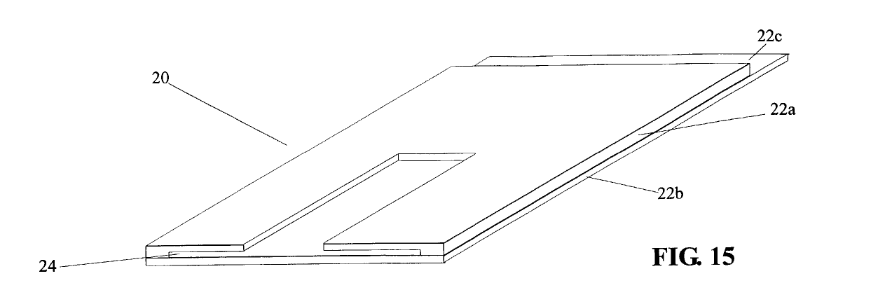

FIG. 15—Alternate Embodiment 9

FIG. 15 illustrates an embodiment of the present invention, where the device is adapted to be a combination portable card read/write device and protective IC card cover. The bottom of the card read/write device 22b provide space 22c for comprising electronic components to couple an inserted card with a computing device, such as a personal computer, an identification device, a payment device or a ticketing device. The space 22c where electronic components are comprised, are preferably covered by the top of the housing, to provide protection to said electronic components. For illustrative purposes the housing of FIG. 15 is not covering the space 22c where the electronic components are comprised.

The card read/write device of FIG. 15 can communicate with said computing devices through various wireless technologies, for example Bluetooth or wireless network technology.

Optionally the embodiment of FIG. 15 can be equipped with a cable connector, to connect for example a USB cable, for other than wirelss communication.

In the embodiment of FIG. 15, the invention can also function as a IC card protecting case. The housing can for example be manufactured of hard plastic or PCB material, which will provide protection to an inserted card. By providing an opening in the housing 22a, an inserted card can conveniently be removed by pressing a finger against said card, and sliding the finger along the opening until the card is extracted from the card read/write device.

The embodiment of FIG. 15 is also very suitable for placement of advertising on the outer surface of both the top 22a and the bottom 22b of the housing.

The comers and edges can be rounded for greater comfort, for example for placement of the device in a pocket.

Conclusion, Ramifications and Scope

It is evident from the foregoing description that the present invention is useful for various applications wherein preservation of space above a PCB is allocated a high priority. The present invention does so without compromising valuable packaging areas or sacrificing sufficient electrical connection between the smart card and the PCB.

By comprising the contacts in the PCB, the connector of the present invention has a size that is significantly reduced from that of the prior art. For a smart card thickness of about 0.80 mm, the thickness of the connector, excluding the thickness of the PCB, is reduced from the prior approximately 2.5 mm to the present approximately 1.8 mm.

Additionally by comprising the contacts in the PCB the manufacture of card read/write device is made considerably simpler than the manufacture of connector contacts of the prior art.

While terms such as “above”, “below”, etc. are used to help describe the invention as it is illustrated, it should be understood that the connector can be used in any orientation. It is also possible to integrate the connector with other devices, to make the angle in which a card is inserted into the connector, adjustable by a user to anywhere between 0 and 180 degrees.

An end position switch can also easily be integrated into the present invention to detect if a card is fully inserted.

In any embodiment of the invention, where the PCB comprise more than 1 set of contacts, the contacts can optionally be configured differently to allow communication with cards of different standards (such as ISO or AFNOR).

In one alternative embodiment of the present invention the card read/write device are manufactured by punching out the contacts of the housing instead of the PCB, and using the PCB or any other material to apply pressure to an inserted card.

In yet another embodiment of the present invention the card read/write device is adapted to electrically couple a conductive RF signal path comprised in the PCB to a contact-less IC card.

Various changes to the foregoing described and shown methods and corresponding structures would now be evident to those skilled in the art. It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector device having means for coupling at least one integrated circuit card with components of said electrical connector device, comprising:
a) a circuit board
b) said circuit board comprising coupling means for coupling an IC card with components of said circuit board.
c) said coupling means being integrated into said circuit board whereby the manufacture of said connector device is greatly simplified and whereby the profile of said connector device is minimized.

2. A connector device of claim 1 wherein
a) said coupling means comprises at least one contact leg
b) said at least one contact leg comprises means for integrating therewith at least one conductive contact head.

3. A connector device of claim 2 wherein
said at least one contact leg is made flush with said circuit board.

4. A connector device of claim 1 wherein:
a) said connector device comprises a housing having means for attaching said housing to said circuit board

5. A connector device of claim 4 wherein:
said circuit board and said housing together form a card insertion ingress.

6. A connector device of claim 5 where
a) said connector device is adapted to form a protective cover for IC cards inserted into said card insertion ingress of said connector device.

7. A connector device of claim 6 further comprising means for coupling said IC card with a computing device.

8. A connector device of claim 5 further comprising means for applying pressure to a card inserted into said card insertion ingress.

9. A connector device of claim 4 wherein said housing is formed by a device selected from the group consisting of:
displays
displays with integrated cursor controls
touch pads
keypads
calculators
biometric authentication devices
contact-less card read/write devices
wireless communication devices
a printed circuit board
a clip attached to said PCB having means for applying pressure to said card
a clip attached to said housing having means for applying pressure to said card.

10. A connector device of claim 4 wherein said housing is formed by a material selected from the group consisting of:
plastic
wood
metal
cardboard
glass
rubber
foam

11. An electrical connector device of claim 1 where in:
a) said coupling means of said connector device comprises means for coupling said connector device to a contact-less integrated circuit card

12. An electrical connector device of claim 11 where in:
said contact-less integrated circuit card is coupled to a conductive path comprised in said circuit board of said connector device.

13. An electrical connector device according to claim 11 having means for coupling a conductive radio frequency path comprised in a circuit board to a contact-less integrated circuit card.

14. An electrical connector device having means for establishing contact to at least one contact pad of an integrated circuit card comprising:
a) a housing which comprises at least one set of electrical contacts
b) a circuit board having means for attaching said housing thereto
c) means for establishing electrical connection between said housing and said circuit board.
whereby the manufacture of said connector device is greatly simplified and
whereby the profile of said connector device is minimized.

15. An electrical connector of claim 14 wherein:
a) said set of electrical contacts comprising at least one contact leg
b) said contact legs being flush with the housing

16. An electrical connector of claim 14 wherein:
a) said contact legs each having means for attaching thereto at least one conductive contact head.

17. A method for coupling an integrated circuit card and a circuit board comprising:
a) integrating into said circuit board coupling means for coupling said circuit board with said integrated circuit card.
b) making said coupling means flush with said circuit board.

18. A method according to claim 17 including forming said coupling means a set of conductive contacts.

19. A method of claim 18 further including:
a) attaching a housing to said circuit board.
b) forming a card insertion ingress between said circuit board and said housing.

20. A method of claim 19 further including:
b) providing means for applying pressure to an IC card inserted into said card insertion ingress.

21. A method according to claim 20 further including removing unwanted parts of said circuit board, to form a set of contact legs out of the material which is left after removing said unwanted material.

22. A method according to claim 21 further including integrating a set of contact heads with said set of contact legs.

23. A method according to claim 17 including integrating into said circuit board wireless communication means to create said coupling means.
